(19) United States
(12) Patent Application Publication
(10) Pub. No.: US 2005/0021688 A1
(43) Pub. Date: Jan. 27, 2005

(54) System and method for domain configuration

(76) Inventors: David Felts, Denville, NJ (US); Thomas Nugent, Boulder, CO (US); Alexander Toussaint, Broomfield, CO (US)

Correspondence Address: FLIESLER MEYER, LLP, FOUR EMBARCADERO CENTER, SUITE 400, SAN FRANCISCO, CA, 94111, US

(21) Appl. No.: 10/780,497

(22) Filed: Feb. 17, 2004

Related U.S. Application Data
(60) Provisional application No. 60/450,126, filed on Feb. 25, 2003.

(51) Int. Cl. G06F 15/177; G06F 15/173

(52) U.S. Cl. 709/220; 709/223

(57) ABSTRACT

A system and method for An interactive tool for configuring a domain, comprising providing a first user interface operable to configure the domain, providing a second user interface operable to configure a cluster, wherein configuration of the domain is based on a domain template, and wherein the cluster belongs to the domain.

### CLAIM OF PRIORITY

This application claims priority from the following application, which is hereby incorporated by reference in its entirety:

SYSTEM AND METHOD FOR DOMAIN CONFIGURATION, U.S. application Ser. No. 60/450,126, Inventors: David Felts et al., filed on Feb. 25, 2003. (Attorney's Docket No. BEAS-1383US0)

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present disclosure relates generally to interactive graphical tools for configuring network resources and, in particular, application/web server configuration tools.

### BACKGROUND

As the use of network domains for management, load-balancing and fail-over increases, so to does the need for easy-to-use domain management tools. Some domain management tools have rigid user interfaces that only accommodate a predefined set of domain configurations. What is needed is an interactive domain tool that is easy to extend.

### BRIEF DESCRIPTION OF THE DRAWINGS

FIG. 1 is an exemplary illustration of a configuration wizard/user interface user interface in accordance to an embodiment.

FIG. 2 is an exemplary illustration of a domain in an embodiment.

FIG. 3 is an exemplary script for creating a new domain from a configuration template in an embodiment.

FIG. 4 is an exemplary script for creating a new domain and updating it using an extension template

### DETAILED DESCRIPTION

Aspects of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

A domain can be defined in which one or more enterprise applications can execute. A domain is the basic administration unit and can include web/application server(s), portal(s), business-to-business integration products, interactive development tool(s), and enterprise applications. In one embodiment, domain creation is based on one or more templates. Templates can contain domain, application and service configuration parameters along with supporting files.

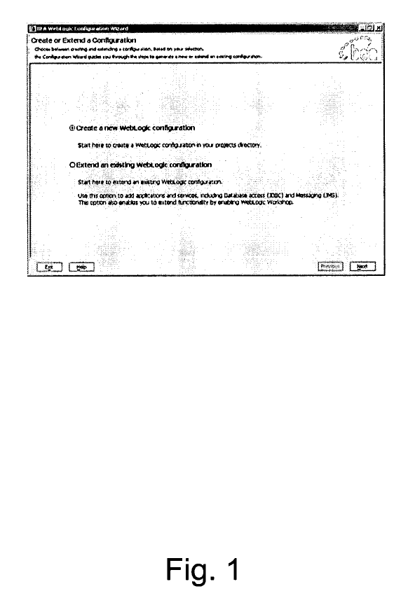

FIG. 1 is an exemplary illustration of a configuration wizard/user interface user interface in accordance to an embodiment. The configuration wizard/user interface can be used to install, configure, monitor, and/or manage one or more domains. In one embodiment, the wizard/user interface can be a Java™ application. The Configuration Wizard/user interface can guide a user through the process of creating or extending a domain for a target environment. This process is based on predefined template(s) that contain the attributes and files required for building or extending a particular domain. In one embodiment, a template can be a Java™ Archive (JAR) file that contains the files and scripts required to create or update a domain.

In one embodiment, the types of templates used by the configuration wizard/user interface can include configuration and extension templates. A configuration template can define the full set of resources within a domain, including infrastructure components, applications, services, security options, and general environment and operating system options. This type of template is used to create a domain. An extension template can define applications and services, such as JDBC (Java™ Database Connectivity) or JMS (Java™ Message Service) components, and startup/shutdown classes, that can be used to extend an existing domain. This type of template is used to update a domain. The applications and services stored in the selected extension templates can be imported into the domain.

The Configuration Wizard/user interface provides two options for creating domains: express and custom configuration. Express configuration allows a user to create a domain quickly, using default settings from a selected configuration template. Custom configuration allows a user to modify configuration information. To customize a domain, a user can specify any of the following components and parameters: Infrastructure components, including managed servers, clusters, and physical host machines; database and messaging services—Java Database Connectivity (JDBC) and Java Message Service (JMS); Targets (servers and clusters); security parameters; and general environment and operating system parameters.

In various embodiments, the Configuration Wizard/user interface can create a domain that includes a configuration file, config.xml, that can describe the infrastructure and basic network parameters of all server instances, and configuration of basic security features that allow for the initial booting of the domain. The domain may also include the following:
Server startup scripts (by way of a non-limiting example, startwebLogic.cmd or startWebLogic.sh) that are populated with the values that a user enter using the Configuration Wizard/user interface;
A directory containing the applications provided by the template;
A directory containing database-specific information used to create and initialize a database; and
Other files and directories to help a user get started (by way of a non-limiting example, setEnv.cmd or setEnv.sh).

In some cases, it may be desirable or necessary to add a predefined application, a component product, or a set of services, such as JDBC or JMS, to an existing domain. By way of a non-limiting example, if a user has an existing Web/app server application running in a domain but needs to develop an Integrated Development Environment (IDE) application to run in the same domain, a user can extend the functionality of the Web/app server domain by adding the IDE.

In one embodiment, to extend a domain using the Configuration Wizard/user interface, a user can select the directory of the domain that the user wants to extend and specify that the extension template include additional applications. A user then has the option of configuring the database (e.g., JDBC) and messaging (e.g., JMS) services, and targeting servers or clusters to which a user want the applications or services deployed. The Configuration Wizard/user interface can then update the config.xml file and all other generated components in the configuration directory, as required.

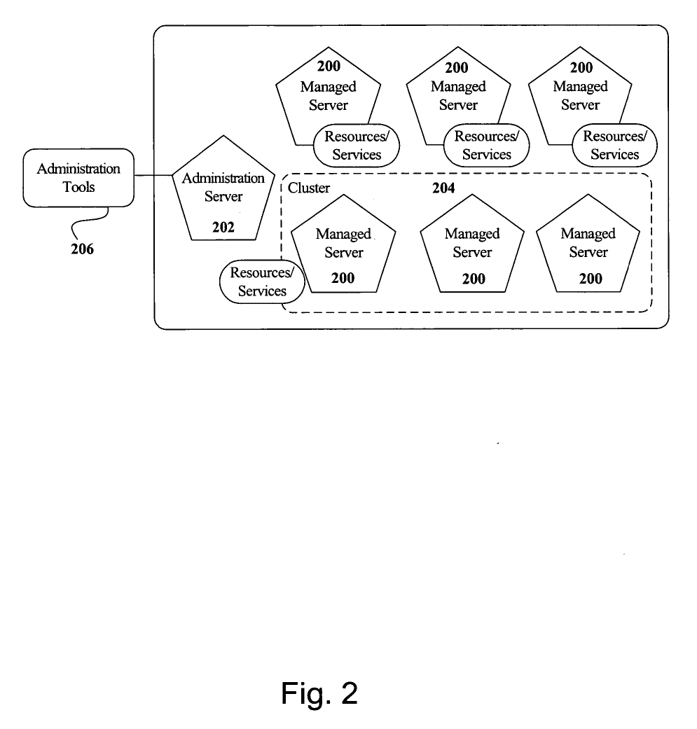

FIG. 2 is an exemplary illustration of a domain in an embodiment. A domain is the basic administration unit for Web/app server. It consists of one or more Web/app server instances 200, and logically related resources and services that are managed, collectively, as a unit. The basic domain infrastructure consists of one Administration Server 202 and optional managed servers 200 and clusters 204. In one embodiment, a domain can include one web/app server instance that is configured as an Administration Server. The Administration Server provides a central point for managing the domain and providing access to the Web/app server administration tools 205. These tools include, but are not limited to, the following: a graphical administration console and a server node manager that enables a user to start, shutdown, restart and monitor servers.

Managed Servers can host application components and resources, which are also deployed and managed as part of the domain. In a domain with only a single Web/app server instance, the server can function as both the Administration Server and Managed Server. A domain may also include Web/app server clusters, which are groups of Web/app server instances that work together to provide scalability and high availability for applications. Clusters can improve performance and provide fail-over should a server instance become unavailable. The servers within a cluster can run on the same machine, or they can reside on different machines. To a client, a cluster appears as a single Web/app server instance.

In addition to infrastructure components, a domain can define the basic network configuration for the server instances it contains. Specifically, a domain can define application deployments, supported application services (such as database and messaging services), security options, and physical host machines.

A user may find it useful to configure multiple domains based on specific criteria, such as system administrator responsibilities, the logical classification of applications, the geographical locations of servers, or size. The following table outlines the most common domain configurations.

TABLE 1
Common Domain Configurations

| FEATURE | DESCRIPTION |
|---|---|
| Domain with | In typical production environments, several |
| Managed Servers | Managed Servers are deployed to host Web |
| | applications, and an Administration Server |
| | is deployed to perform management operations. |
| Domain with | In production environments that require |
| Managed Servers | increased performance, Cluster throughput, |
| and Clusters | or availability for a Web application, |
| | several Managed Servers might be grouped |
| | in a cluster. In such a case, the domain |
| | consists of one or more clusters with the |
| | applications they host, additional Managed |
| | Servers, if necessary, and an Administration |
| | Server to perform management operations. |
| Stand-alone | In development or test environments, a single |
| Server Domain | application and server might be deployed |
| | independently from other Managed Servers. In |
| | such a case, a user can deploy a domain |
| | consisting of a single Administration Server |
| | that also hosts the Web applications a user |
| | want to test or develop. The Web/app server |
| | Examples Domain template, described in the |
| | Template Reference, is an example of a |
| | stand-alone server domain. |

In one embodiment, the Configuration wizard/user interface can be invoked in graphical mode or silent mode. To run it in silent mode, a user can first create a script that can define the configuration settings for the domain. A script can specify operations to be performed by the Configuration Wizard/user interface when the script is executed. The following sections describe the operations that can be defined in the script to create a new domain. First, a pre-existing configuration template can be selected to use as the basis of the domain a user will create and configure. Then' the information in the template can be customized to create new configuration objects, edit existing values for configuration object attributes, or delete configuration objects. In one embodiment, a user can obtain information about a user existing configuration by viewing the config.xml and security.xml files in a user template or domain. In one embodiment and by way of a non-limiting example, the following table can define the configuration objects that can be created and edited.

TABLE 2
Exemplary Configuration Object Types in an Embodiment

| CONFIGURATION OBJECT | |
|---|---|
| TYPE | WHAT IS DEFINED? |
| Server | Administration or Managed Server. |
| Cluster | Cluster. |
| Machine | Windows machine. |
| UnixMachine | UNIX machine. |
| JDBCConnectionPool | JDBC Connection Pool. |
| JDBCMultiPool | JDBC MultiPool. |
| JDBCDataSource | JDBC data source. |
| JDBCTxDataSource | JDBC data source that supports |
| | global transactions. |
| JMSConnectionFactory | JMS connection factory. |
| JMSDestinationKey | JMS destination key. |
| JMSServer | JMS Server. |
| JMSFileStore | JMS file store. |
| JMSJDBCStore | JMS JDBC store. |
| JMSTemplate | JMS Template. |
| JMSTopic | JMS topic. |
| JMSQueue | JMS queue. |
| JMSDistributedTopic | JMS distributed topic. |
| JMSDistributedQueue | JMS distributed queue. |
| JMSDistributedTopicMember | JMS distributed topic members. |
| JMSDistributedQueueMember | JMS distributed queue members. |
| User | User. |
| Group | Group. |

A configuration is specified in a template file as follows:
create object_type “name” as variable;
   where object_type is the configuration object type (see Table 2), name is how the object will be referred to, and variable is a user-defined variable used to specify the configuration object.

In the following example, a Server object is created and assigned to the variable s2, and the Name attribute is set to server_{—}2:
create Server “server_{—}2” as s2;

In the following example, a User object is created and assigned to the variable u1, and the Name attribute is set to user1:
create User “user1” as u1;

In one embodiment and by default, the user is assigned to the group “Administrators.”

Before a user can edit an existing configuration object, the configuration wizard/user interface can find the object in the template and assign it to a variable. To assign a configuration object to a variable, use the find operation, as follows:
find object_type “name” as variable;
   where object_type is a configuration object, name is the value of the configuration object Name attribute, and variable is a user-defined variable used to specify the configuration object.

In the following example, a Server object named “myserver” is assigned to the variable s1:
find Server “myserver” as s1;

To set a configuration attribute, specify the variable and attribute name for it, as follows:
set variable.attribute “value”;
   where variable is a user-defined variable used to specify the configuration object, attribute is a configuration object attribute value, and value is a value that a user want to assign to the specified attribute of the configuration object. The value can be enclosed in quotation marks.

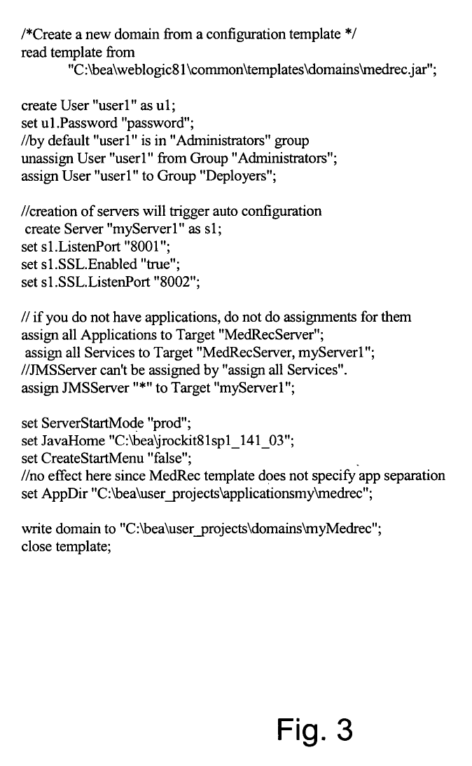

FIG. 3 is an exemplary script for creating a new domain from a configuration template in an embodiment.

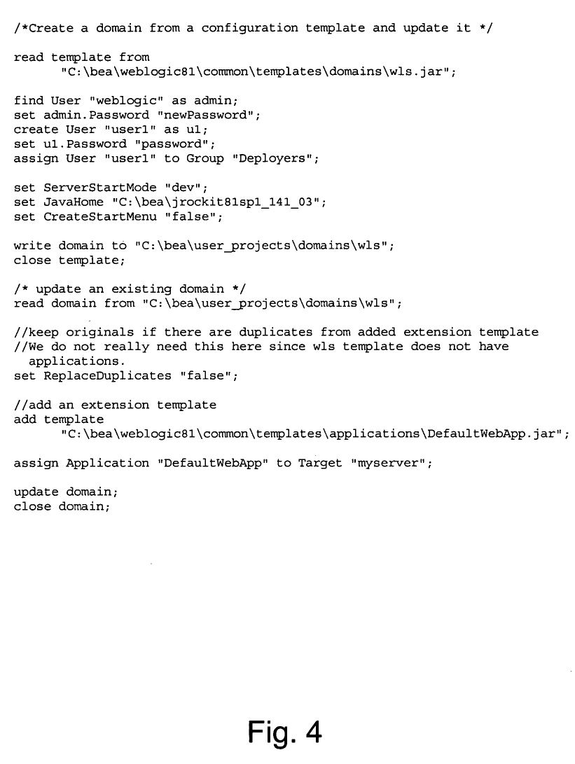

FIG. 4 is an exemplary script for creating a new domain and updating it using an extension template

Table 3 summarizes the procedure for creating a domain using the custom configuration option in an embodiment Configuration wizard/user interface.

TABLE 3
Exemplary Tasks for Creating a
Custom Domain in an Embodiment

| TASK | DESCRIPTION |
|---|---|
| Creating or Extending | Choose whether to create a new WebLogic |
| a Configuration | domain configuration or add to an |
| | existing domain configuration. To create |
| | a new domain, choose Create a new WebLogic |
| | configuration. |
| Selecting a Configuration | Choose the configuration template with |
| Template | which a user want to create and configure |
| | a user domain. |
| Choosing Express or | Select the Custom option to create a domain |
| Custom Configuration | with non-default template settings that |
| | meet the needs of a user domain. |
| Designating an | Designate a server as the Administration |
| Administration Server | Server. This window is displayed |
| | automatically only if the selected template |
| | includes multiple servers that are not |
| | assigned to clusters. |
| Configuring the | Define parameters for the Administration |
| Administration Server | Server, a designated server from which the |
| | domain is managed. |
| Configuring Managed | Optionally, define parameters for Managed |
| Servers, Clusters, | Servers, clusters, and host machines. |
| and Machines When | |
| Creating a New Domain | |
| Configuring JDBC When | Optionally, define parameters for Java |
| Creating a New Domain | Database Connectivity (JDBC). |
| Configuring JMS When | Optionally, define parameters for the Java |
| Creating a New Domain | Message Service (JMS). |
| Targeting Servers and | Optionally, target the servers and clusters |
| Clusters When Creating | to which a user want to deploy application |
| a New Domain | components (such as Web applications and |
| | EJB modules), and application services |
| | (such as JDBC or JMS components, and |
| | startup/shutdown classes.) |
| Configuring Security | Specify an administrative username and |
| When Creating a New | password. |
| Domain | Optionally, a user can also configure |
| | additional security features by defining |
| | users and groups and assigning them |
| | to global security roles. |
| Configuring Windows | Optionally, define domain-specific |
| Options | parameters for the Windows operating system. |
| Specifying the | Select the mode in which to launch a user |
| WebLogic | WebLogic domain configuration (development |
| Configuration | mode or production mode) and the Java |
| Environment | Software Development Kit (SDK) that is |
| | enabled for the selected Startup mode. |
| Creating the | Review the parameters defined for a user |
| WebLogic | domain configuration, specify its name |
| Configuration | and pathname, and initiate its creation. |

In various embodiments, the configuration wizard/user interface can prompt a user to choose whether a user want to create a new domain configuration or extend an existing one by adding applications and services. To create a new domain, a user begins by selecting a configuration template as the basis for a user domain and then modifies settings as needed. To add applications and services to an existing domain configuration, a user begins by selecting the extension template to modify.

The configuration wizard/user interface can prompt a user to define configuration information for the Administration Server. A user can review the values displayed in the window and modify them as necessary, using the guidelines provided in the following table. Exemplary values in one embodiment are provided in Table 4.

TABLE 4
Exemplary Admin Server Configuration
Parameters in an Embodiment

| FIELD | DESCRIPTION |
|---|---|
| Name | A valid server name: a string of characters that can |
| | include spaces. Each server instance in a user |
| | environment can have a unique name, regardless of |
| | the domain or cluster in which it resides, or |
| | whether it is an Administration Server or a Managed |
| | Server. In addition, the name of the Administration |
| | Server can be unique among all configuration |
| | component names within the domain. |
| Listen | From a drop-down list, a user can select a value for |
| Address | the Listen Address. Valid values for the listen |
| (Optional) | address are as follows: |
| | All Local Addresses (default) |
| | IP address of the computer that hosts the server |
| | DNS name that resolves to the host |
| | localhost (valid only for requests that are issued |
| | from the computer on which the server is running) |
| Listen Port | A valid value for the listen port to be used for |
| (Optional) | regular, non-secure requests (via protocols such |
| | as HTTP and T3). The default value is 7001. If a |
| | user leave this field blank, the default value |
| | is used. |
| SSL Listen | SSL Listen Port Enter a valid value to be used for |
| Port | secure requests (via protocols such as HTTPS and |
| (Optional) | T3S). The default value is 7002. If a user |
| | leave this field blank, the default value is used. |
| SSL Enabled | Select the check box if a user want to enable the |
| (Optional) | SSL Listen Port. By |
| | default, the SSL is disabled for all new servers. |

In one embodiment, the minimum requirement for a user domain is a single Administration Server on a single machine. In addition, however, a user has the option of configuring other resources to be managed by the Administration Server and distributing them across multiple machines. A user can: add, change, or delete managed servers; add, change, or delete clusters; group managed servers into clusters, or change current groupings; and assign servers to machines, or change current assignments. The configuration wizard/user interface can prompt a user to specify whether a user want to distribute configuration across Managed Servers, clusters, and physical machines.

JDBC enables Java™ programmers to interact with common database management systems (DBMS), such as Oracle, Microsoft SQL Server, and Sybase. The Configuration Wizard/user interface gives a user the option of configuring a database service for a user domain by defining several WebLogic JDBC components: Connection pools—Ready-to-use groups of connections to a user DBMS; MultiPools-Groups of connection pools; and Data sources—Interfaces between applications and connection pools. Because Web/app server applications usually require some database access, templates created for use with the Configuration Wizard/user interface can contain JDBC configuration information. When using the Configuration Wizard/user interface, a user can accept these settings, modify them, or add JDBC configuration information.

JMS gives a user access to enterprise messaging systems that enable applications to communicate with one another. The Configuration Wizard/user interface gives a user the option of setting up JMS messaging services for a domain. To set up a messaging service, a user can define the following components:
Connection factory—Encapsulated connection configuration information that enables JMS applications to create a connection.
File and JDBC stores—Disk-based file stores and JDBC-accessible database stores, respectively; used to store persistent messages.
Destination Keys and JMS Templates—Keys to define the sort order for messages that arrive at a destination and templates to define multiple destinations with similar attribute settings.
JMS Servers—Servers that manage connections and message requests on behalf of clients.
Destinations—Queues (in point-to-point models) or topics (in publish/subscribe models) that serve as destinations and distributed destinations for a JMS server.

Because JMS is often required by Web/app server applications, the templates created for use with the Configuration Wizard/user interface can contain JMS configuration information. A user can accept these settings when using the Configuration Wizard/user interface.

In one embodiment, the configuration wizard/user interface can prompt a user to decide whether a user want to define additional infrastructure components and distribute the domain across those components.
If a user selects No, the wizard/user interface uses the configuration settings based on a configuration source that a user selected earlier.

If a user selects Yes, the user is prompted in subsequent windows to define the configuration a user want, as described in the Table 5.

TABLE 5
Exemplary Tasks for Configuring Servers
and Clusters in an Embodiment

| TASK | DESCRIPTION |
|---|---|
| Configuring Managed | Optionally, add managed servers or change |
| Servers | the configuration of existing managed |
| | servers in a user domain. |
| Grouping Managed | A cluster is a group of Web/app server |
| Servers into Clusters | instances that work together to provide |
| | scalability and high-availability for |
| | applications. |
| Mapping Web/app | In a domain, a machine is the computer |
| server Instances to | hardware that hosts one or more |
| Host Machines | Web/app server instances. |

To configure clusters, a user can review a current list of cluster configurations and add or modify entries as required using the guidelines provided in Table 6.

TABLE 6
Exemplary Cluster Configuration Parameters in an Embodiment

| FIELD | DESCRIPTION |
|---|---|
| Name | Valid cluster name: a string of characters that can |
| | include spaces. The name of the cluster can be |
| | unique among all configuration component names |
| | within the domain. |
| Multicast | Multicast address for the cluster. This address is |
| Address | used by cluster members to communicate with each |
| (Optional) | other. The default value is 237.0.0.1. |
| | Valid multicast addresses are any valid IP address |
| | of the form nnn.xx.xx.xxxx, where nnn is 237, 238, |
| | or 239. |
| Multicast | Multicast port for the cluster. The multicast port |
| Port | is used by cluster members to communicate with each |
| (Optional) | other. The default value is 7777. |
| Cluster | Cluster address that identifies the Managed Servers |
| Address | in the cluster. |
| (Optional) | A cluster address can be one of the following: |
| | Comma-separated list of IP addresses or DNS names |
| | and ports, by way of a non-limiting example: |
| | dns_name:port, dns_name:port |
| | DNS name that maps to multiple IP addresses |
| | localhost, DNS name, or IP address if the Listen |
| | Address of all Managed Servers is listening to the |
| | same address with unique port numbers |
| | The cluster address is used in entity and stateless |
| | EJBs to construct the host name portion of URLs. |
| | If the cluster address is not set, EJB handles may |
| | not work properly. |

In one embodiment, a Cluster Wizard/user interface user interface can prompt a user to assign the available Managed Server(s) to a cluster within the domain. This wizard/user interface is displayed only if a user have defined at least one cluster. The cluster wizard/user interface prompts a user to create an HTTP proxy application to proxy client requests to the cluster. An HTTP proxy application operates as an intermediary for HTTP requests.

In one embodiment, another wizard/user interface prompts a user to define the configuration information for the Windows and UNIX machines in the domain (see Table 7). A user may want to perform this in circumstances such as (but not limited to) the following: an Administration Server uses the machine definition, in conjunction with the Node Manager application, to start remote servers; and a Web/app server uses configured machine names when determining which server in a cluster is best able to handle certain tasks, such as HTTP session replication. Web/app server then delegates those tasks to the identified server.

TABLE 7
Exemplary Machine Configuration Parameters in an Embodiment

| PARAMETER | DESCRIPTION |
|---|---|
| Name | Enter a valid machine name: a string of characters |
| | that can include spaces. |
| | The machine name: |
| | Is used to identify the machine within the Web/app |
| | server domain; it is not required to match the |
| | network name for the machine. |
| | Can be unique among all configuration component |
| | names within the domain. |
| Node Manager | Select a value from the drop-down list for the |
| Listen Address | listen address used by the Node Manager. By |
| (Optional) | default, the IP addresses defined for the local |
| | system and localhost are shown in the drop-down |
| | list. The default is localhost. |
| | Valid values for the listen address are as follows: |
| | IP address of the computer that hosts the server |
| | DNS name that resolves to the host |
| | localhost |
| | All Local Addresses |
| Node Manager | Enter a valid value for the listen port used by |
| Listen Port | the Node Manager. |
| (Optional) | Any number between 1 and 65535 is a valid value. |
| | The default value is 5555. |

In one embodiment, a user can configure a database service such as but not limited to JDBC. JDBC enables Java programmers to interact with common database management systems such as Oracle, Microsoft SQL Server, Sybase. A wizard/user interface gives the user the option of configuring a database service by defining several JDBC components in Table 8.

TABLE 8
Exemplary Tasks for Configuring JDBC in an Embodiment

| TASK | DESCRIPTION |
|---|---|
| Configuring JDBC | Create ready-to-use pools of connections to a |
| Connection Pools | user DBMS. This task is a prerequisite for |
| (Optional) | configuring JDBC MultiPools. |
| Configuring JDBC | Set up a group of JDBC connection pools to |
| MultiPools | accommodate either a high-availability |
| (Optional) | algorithm or a load-balancing algorithm. |
| Assigning JDBC | Assign the JDBC connection pools to the |
| Connection Pools | defined JDBC MultiPools. |
| to MultiPools | This window only is displayed only if a user |
| (Optional) | define one or more JDBC connection pools and |
| | JDBC MultiPools. |
| Configuring JDBC | Configure the data sources that are bound |
| Data Sources | to the JNDI tree and assign a JDBC connection |
| (Optional) | pool. A data source object enables |
| | JDBC applications to obtain a DBMS connection |
| | from a connection pool. |
| Testing JDBC | Test a user JDBC connection pool configurations |
| Connection Pools | on the local machine. |
| and Setting Up a | |
| JDBC | |
| Database(Optional) | |
| Setting Up the | Set up the database content used by the |
| JDBC Database | applications in a user domain using pre-existing |
| Content (Optional) | SQL or database loading files. A configuration |
| | template may contain a set of SQL files organized |
| | by database type. |

In one embodiment, a user can configure JMS. A wizard/user interface gives a user access to enterprise messaging systems that make it possible for applications to communicate with one another. In one embodiment, JMS configuration parameters are listed in Table 9.

TABLE 9
Exemplary Tasks for Configuring JMS in an Embodiment

| TASK | DESCRIPTION |
|---|---|
| Configuring JMS | Configure connection factories, JMS objects that |
| Connection | encapsulate connection configuration information, |
| Factories | and enable JMS applications to create connections. |
| Configuring JMS | Configure JMS destination keys that are used to |
| Destination Keys | define the sort order for messages that arrive |
| | at a specific destination. |
| Configuring JMS | Configure JMS templates which provide an |
| Templates | efficient means of defining multiple destinations |
| | (queues and topics) with similar configuration |
| | settings. |
| Assigning JMS | Assign destination keys to templates. |
| Destination Keys | |
| Configuring JMS | Configure JMS file stores. A JMS file store is |
| File Stores | a disk-based file that is used to store |
| | persistent messages. |
| Configuring JMS | Configure JMS JDBC stores, a JDBC-accessible |
| JDBC File Stores | database used to store persistent messages. |
| Configuring JMS | Configure JMS servers to manage connections |
| Servers | and message requests on behalf of clients. |
| Assigning JMS | Assign the JMS servers to Web/app server |
| Servers to Web/app | instances. |
| server Instances | |
| Configuring IMS | Configure JMS topics. JMS topics support the |
| Topics | publish/subscribe (Pub/sub) messaging model |
| | which enables an application to send a |
| | message to multiple applications. Pub/sub |
| | messaging applications send and receive |
| | messages by subscribing to a topic. |
| Configuring JMS | Configure JMS queues. JMS queues support the |
| Queues | point-to-point (PTP) messaging model which |
| | enables one application to send a message to |
| | another application. PTP messaging applications |
| | send and receive messages using named queues. |
| Configuring JMS | Configure JMS distributed topics, a set of |
| Distributed Topics | physical topics that can support service |
| | continuity in the event of a Web/app server |
| | failure within a cluster. |
| Configuring JMS | Configure JMS distributed queues, a set of |
| Distributed Queues | physical queues that can support service |
| | continuity in the event of a Web/app server |
| | failure within a cluster. |
| Assigning JMS | Assign JMS distributed queues or topics to |
| Distributed | a Web/app server or cluster. |
| Destinations | |
| Configuring JMS | Assign members to a particular JMS |
| Distributed Topic | distributed topic. |
| Members | |
| Configuring JMS | Assign members to the JMS distributed queue. |
| Distributed Queue | |
| Members | |

Targeting of applications and services (e.g., JMS and JDBC) to servers or clusters is optional. A wizard/user interface (not shown) can allow a user to target the servers and clusters onto which a user want to deploy applications and services.

In some situations, a user may need to extend an existing domain with an application, a component product, or a set of services. By way of a non-limiting example, if a user needs to develop an IDE application for a domain in which a user are already running a Web/app server application, a user can extend the functionality of the domain by adding IDE to it. The Configuration Wizard/user interface simplifies the task of extending an existing domain by using extension templates. An extension template can define applications and services that can be added to an existing domain. BEA delivers a set of predefined extension templates, which are described in Template Reference. Table 10 summarizes a procedure for extending an existing domain using the Configuration Wizard/user interface in one embodiment.

TABLE 10
Exemplary Tasks for Extending a Domain in an Embodiment

| TASK | DESCRIPTION |
|---|---|
| Creating or Extending a | Choose whether to create a new WebLogic |
| Configuration | domain configuration or add to an |
| | existing domain configuration. To |
| | extend an existing domain configuration, |
| | choose Extend an existing WebLogic |
| | configuration. |
| Choosing a WebLogic | Select the host directory for the domain |
| Configuration Directory | a user want to update. |
| Selecting a | Specify an extension (or application) |
| Configuration Extension | template that allows a user to add |
| Template | applications and services to an existing |
| | domain. |
| Configuring JDBC | Define parameters for Java Database |
| When Extending a | Connectivity (JDBC). |
| Domain | |
| Configuring JMS When | Define parameters for Java Message |
| Extending a Domain | Service (JMS). |
| Targeting Applications | Define parameters for the target servers |
| and Services to Servers | and clusters onto which a user want to |
| and Clusters When | deploy application components, such as |
| Extending a Domain | Web applications and EJB modules, and |
| | application services, such as JDBC or |
| | JMS components, or startup and |
| | shutdown classes. |
| Configuring JMS | Review a user current configuration |
| Domain Creating A | settings and launch the process that |
| user WebLogic | updates the domain. |

A configuration template can define the full set of resources within a domain, including infrastructure components, applications, services, security options, and general environment and operating system parameters. In various embodiments, a Configuration Template Builder makes it easy to create templates. By way of a non-limiting example, the template builder enables:
Definition and propagation of a standard domain across a development project
Distribution of a domain along with an application that has been developed to run on that domain

Any template a user create with the Configuration Template Builder can be used as input to the Configuration Wizard/user interface. The Configuration Wizard/user interface uses it, in turn, as the basis for creating a domain that is customized for a user target environment. Table 11 summarizes the procedure for creating a configuration template using the Configuration Template Builder.

TABLE 11
Tasks for Creating a Template in an Embodiment

| STEP | DESCRIPTION |
|---|---|
| Creating a New Template | Choose the type of template a user want |
| | to create: configuration or extension. |
| | To create a configuration template, |
| | choose Create a Configuration Template. |
| Selecting a Template | Select the configuration template or the |
| Configuration Source | directory of the domain from which a |
| | user want to create a new configuration |
| | template. |
| Describing the Template | Specify a description of the template |
| | that will be displayed within the Select |
| | a Configuration Template window of the |
| | Configuration Wizard/user interface. |
| Adding Applications to | Review and modify, if desired, the list |
| A user Configuration | of applications to be included in the |
| Template | template. |
| Adding Files to A user | Review and modify, if desired, the files |
| Configuration Template | to be included in the template. |
| Adding SQL Scripts Into | Add SQL scripts for each database that |
| A user Configuration | a user expect to be used with the |
| Template | domains created from this template and |
| | specify the order in which the scripts |
| | are executed. |
| Configuring Managed | Optionally, define parameters for the |
| Servers, Clusters, and | Managed Servers, clusters, and host |
| Machines When Creating | machines in a user domain. |
| Configuration Templates | |
| Configuring JDBC When | Optionally, define parameters for Java |
| Creating Configuration | Database Connectivity (JDBC). |
| Templates | |
| Configuring JMS When | Optionally, define parameters for Java |
| Creating Configuration | Message Service (JMS). |
| Templates | |
| Targeting Servers and | Optionally, define parameters for the |
| Clusters When Creating | target servers and clusters onto which a |
| Configuration Templates | user want to deploy application components |
| | (such as Web applications and EJB modules) |
| | and application services (such as JDBC or |
| | JMS components), or startup and shutdown |
| | classes. |
| Configuring Security | Specify a user name and password to be |
| When Creating | used for starting the |
| Configuration Templates | Administration Server and, if desired, |
| | configure additional security. |
| Building Start Menu | Optionally, define entries for the |
| Entries | Windows Start Menu. |
| Preparing Scripts and | Replace specific paths, filenames, and |
| Files With Replacement | other configuration environment settings |
| Variables | with replacement variables in text files |
| | contained in the template. The |
| | Configuration Wizard/user interface |
| | later substitutes the variables with |
| | exact strings to set up a specific |
| | WebLogic configuration. |
| Creating A user | Review the configuration template |
| Configuration Template | details, specify the name and directory |
| | for the configuration template, and |
| | launch the process that creates it. |

In one embodiment, an extension template can define applications and services that can be used to extend an existing domain. This type of template can be used when a user is updating a domain. The applications and services stored in the selected extension templates can be imported into the domain using the Configuration Wizard/user interface. The Configuration Template Builder provides a simple means for creating extension templates which can be used as input to the Configuration Wizard/user interface. The process used to create an extension template is virtually the same as the process used to create a configuration template except that a user are not prompted to define any infrastructure components.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing description of the preferred embodiments of the present invention have been provided for the purposes of illustration and description. It is not intended to be exhaustive or to limit the invention to the precise forms disclosed. Many modifications and variations will be apparent to the practitioner skilled in the art. Embodiments were chosen and described in order to best explain the principles of the invention and its practical application, thereby enabling others skilled in the art to understand the invention, the various embodiments and with various modifications that are suited to the particular use contemplated. It is intended that the scope of the invention be defined by the following claims and their equivalents.

1. An interactive tool for configuring a domain, comprising:
providing a first user interface operable to configure the domain;
providing a second user interface operable to configure a cluster;
wherein configuration of the domain is based on a domain template; and
wherein the cluster belongs to the domain.

2. The interactive tool of claim 1 wherein the first user interface includes:
an option to select the domain template.

3. The interactive tool of claim 1 wherein the first user interface includes:
an option to customize the domain template.

4. The interactive tool of claim 1 wherein:
the domain includes an administration server and a set of resources and/or services that can be managed as a unit.

5. The interactive tool of claim 1 wherein:
the domain template includes a set of configuration parameters.

6. The interactive tool of claim 5 wherein:
the set of configuration parameters includes at least one of: 1) an application; 2) a server; 3) information related to configuring a database; 4) information related to configuring a message service; and 5) information related to configuring a cluster.

7. The interactive tool of claim 1 wherein:
the domain template is a Java Archive (JAR) file.

8. The interactive tool of claim 1, further comprising:
a third user interface to designate and/or configure an administration server.

9. The interactive tool of claim 1 wherein the second user interface includes:
an option to add, change and/or delete a managed server;
an option to add, change and/or delete the cluster; and
an option to designate a server as part of the cluster.

10. The interactive tool of claim 1 wherein:
the cluster includes a set of servers that work together to provide scalability and high availability for an application.

11. A method for configuring a domain with an interactive tool, comprising:
selecting a domain template with the interactive tool;
configuring the domain based on the domain template;
wherein the domain template can be customized; and
wherein the domain template includes a set of configuration parameters.

12. The method of claim 11 wherein:
the domain includes an administration server and a set of resources and/or services that can be managed as a unit.

13. The method of claim 11 wherein:
the set of configuration parameters includes at least one of: 1) an application; 2) a server; 3) information related to configuring a database; 4) information related to configuring a message service; and 5) information related to configuring a cluster.

14. The method of claim 11 wherein:
the domain template is a Java Archive (JAR) file.

15. The method of claim 11 wherein the interactive tool includes:
an option to designate and/or configure an administration server.

16. The method of claim 11 wherein the interactive tool includes:
an option to add, change and/or delete a managed server;
an option to add, change and/or delete a cluster; and
an option to designate a server as part of a cluster.

17. The method of claim 16 wherein:
a cluster includes a set of servers that work together to provide scalability and high availability for an application.

18. A machine readable medium having instructions stored thereon that when executed by a processor cause a system to allow a user to:
select a domain template with an interactive tool;
configure a domain based on the domain template;
wherein the domain template can be customized; and
wherein the domain template includes a set of configuration parameters.

19. The machine readable medium of claim 18 wherein:
the domain includes an administration server and a set of resources and/or services that can be managed as a unit.

20. The machine readable medium of claim 18 wherein:
the set of configuration parameters includes at least one of: 1) an application; 3) a server; 3) information related to configuring a database; 4) information related to configuring a message service; and 5) information related to configuring a cluster.

21. The machine readable medium of claim 18 wherein:
the domain template is a Java Archive (JAR) file.

22. The machine readable medium of claim 18 wherein the interactive tool includes:
an option to designate and/or configure an administration server.

23. The machine readable medium of claim 18 wherein the interactive tool includes:
an option to add, change and/or delete a managed server;
an option to add, change and/or delete a cluster; and
an option to designate a server as part of a cluster.

24. The machine readable medium of claim 23 wherein:
a cluster includes a set of servers that work together to provide scalability and high availability for an application.

25. A computer data signal embodied in a transmission medium, comprising:
a code segment including instructions to select a domain template with an interactive tool;
a code segment including instructions to configure a domain based on the domain template;
wherein the domain template can be customized; and
wherein the domain template includes a set of configuration parameters.
